(19) United States
(12) Patent Application Publication
(10) Pub. No.: US 2009/0230118 A1
(43) Pub. Date: Sep. 17, 2009

(54) WATER-COOLER COMPATIBLE CYLINDER TRAY FOR WELDING MACHINE

(75) Inventors: Benjamin Romenesko, Hortonville, WI (US); Chris J. Roehl, Appleton, WI (US)

Correspondence Address: FLETCHER YODER (ILLINOIS TOOL WORKS INC.), P.O. BOX 692289, HOUSTON, TX, 77269-2289, US

(73) Assignee: Illinois Tool Works Inc., Troy, OH (US)

(21) Appl. No.: 12/402,409

(22) Filed: Mar. 11, 2009

Related U.S. Application Data
(60) Provisional application No. 61/036,665, filed on Mar. 14, 2008.

(51) Int. Cl. H05B 3/06

(52) U.S. Cl. 219/520

(57) ABSTRACT

A novel system for securing accessory equipment to a welding machine is provided. The invention provides a tray secured to the lower portion of a welding machine and a holder secured to the upper portion of the welding machine for stabilization and support of a water cooler and/or a gas cylinder in the formed recesses. Risers or lifting tabs are provided on the tray, which form a recess for placement of the water cooler and/or gas cylinder. A restraining member is provided for the securement of the water cooler and/or gas cylinder on the tray in the formed recesses. The tray is designed to support axles for receiving wheels to enable portability of the system.

### CROSS REFERENCE TO RELATED APPLICATIONS

This application is a Non-provisional Patent Application of U.S. Provisional Patent Application No. 61/036,665, entitled “Water-Cooler Compatible Cylinder Tray on MIG Welding Machine”, filed Mar. 14, 2008, which is herein incorporated by reference.

### BACKGROUND

The invention relates generally to welding machines, and more particularly to systems for securing accessory equipment, such as water coolers and gas cylinders, to welding machines.

Welding guns are a key component of any welding system and can reach extreme temperatures during operations due to their close proximity to the welding arc. Accordingly, some welding guns are provided with convection cooling systems, such as air-cooled systems and water-cooled systems for proper gun maintenance. Water-cooled guns dissipate heat at faster rates than do air-cooled guns, minimizing heat buildup and operating temperatures. However, water-cooled systems necessitate somewhat bulky water coolers that, if the welder is to be moved, require their own cart, thereby reducing their practicality, or at least their convenience in industrial applications. Since welding systems must be transported to the welding site, air-cooled systems are often chosen for their portability.

Choosing between a water-cooled and an air-cooled system becomes a tradeoff between productivity and portability, giving rise to an engineering problem. Incorporation of the water cooler on the self-contained welding power source unit that sits on wheels would allow the portability of an air-cooled system to be combined with the productivity of a water-cooled system. Therefore, there exists a need for improved welding systems that incorporate the additional components of a water-cooled system on the single mobile unit. Such a system would allow for the cooling capabilities of water-cooled systems to be fully recognized in industrial practice.

### BRIEF DESCRIPTION

The present invention provides a novel system for securing accessory equipment to a welding machine designed to respond to such needs. The invention allows for the incorporation of a water cooler onto a welding power source or along with a gas cylinder where desired. In particular, the invention provides a tray secured to the lower portion of a welding machine and a holder secured to the upper portion of the welding machine for stabilization and support of a water cooler and/or a gas cylinder in recesses formed for this purpose. Risers or lifting tabs may be provided on the tray, which form a recess for placement of the water cooler and/or gas cylinder and that may also facilitate unloading the gas cylinder. The tray may be designed to support axles for receiving wheels to enable portability of the system. Certain embodiments provide a restraining member, such as a chain, bracket, and so forth, which fits into apertures in the holder and surrounds the water cooler and/or gas cylinder.

### DRAWINGS

These and other features, aspects, and advantages of the present invention will become better understood when the following detailed description is read with reference to the accompanying drawings in which like characters represent like parts throughout the drawings, wherein:

FIG. 1 is a top perspective view of an exemplary welding system illustrating a bracket and a tray that secure a gas cylinder in accordance with aspects of the present invention;

FIG. 2 is a top perspective view of the exemplary welding system of FIG. 1 securing a water cooler on a tray with a bracket;

FIG. 3 is an exploded top perspective view of the exemplary welding system of FIG. 2;

FIG. 4 is a top perspective view of an exemplary bracket for securement of a single gas cylinder or water cooler on a tray;

FIG. 5 is a top perspective view of an exemplary tray for securement of a single gas cylinder or water cooler;

FIG. 6 is a top perspective view of an exemplary welding system securing both a gas cylinder and a water cooler on a tray with a bracket;

FIG. 7 is an exploded top perspective view of the exemplary welding system of FIG. 6;

FIG. 8 is a top perspective view of an exemplary bracket for securement of both a gas cylinder and a water cooler on a tray; and

FIG. 9 is a top perspective view of an exemplary tray for securement of both a gas cylinder and a water cooler.

### DETAILED DESCRIPTION

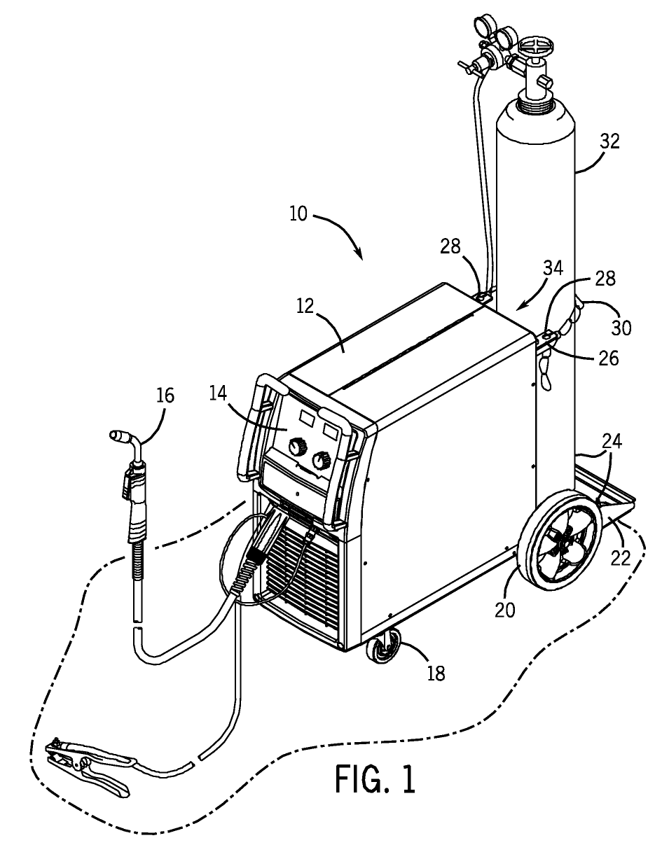

FIG. 1 illustrates an exemplary welding system 10, which powers, controls, and provides supplies to a welding operation. The side of a welding machine 12 that faces the welder contains a control panel 14 through which the welder may control the supply of welding materials, such as gas flow, wire feed, and so forth, to the welding gun 16. The portability of the welding system 10 depends on a set of smaller front wheels 18 and a set of larger back wheels 20, which enable the welder to move the welding system 10 to the location of the weld.

A tray 22 with a set of risers or lifting tabs 24 is used in combination with a bracket 26 containing apertures 28 and a securement apparatus 30 to secure a gas cylinder 32 on the rear portion of the welding machine 12. The bracket 26 is secured to the upper portion of the back side of the welding machine 12 and, in the illustrated embodiment, forms a square recess in which the top portion of the cylinder 32 is positioned. It should be appreciated, however, that the particular form and shape of such recesses may differ, particularly upon the anticipated shape or configuration of the items to be received and supported on the tray. A securement apparatus 30 fits in the apertures 28 and extends around the top portion of the gas cylinder 32 to secure it within the bracket 26. The securement apparatus 30 may be but is not limited to a chain, rope, a metal bracket, and so forth. The tray 22 is positioned on the lower portion of the back side of the welding machine 12. The set of risers or lifting tabs 24 creates a recess in the tray 22 in which the bottom portion of the gas cylinder 32 is placed for stabilization. The corners of the risers or lifting tabs 24 may be different shapes, such as square, circular, and so forth. In certain embodiments, the risers or lifting tabs 24 may be secured to the tray 22 permanently. In other embodiments, the risers or lifting tabs 24 may be removably secured for ease of loading and unloading of the gas cylinder 32.

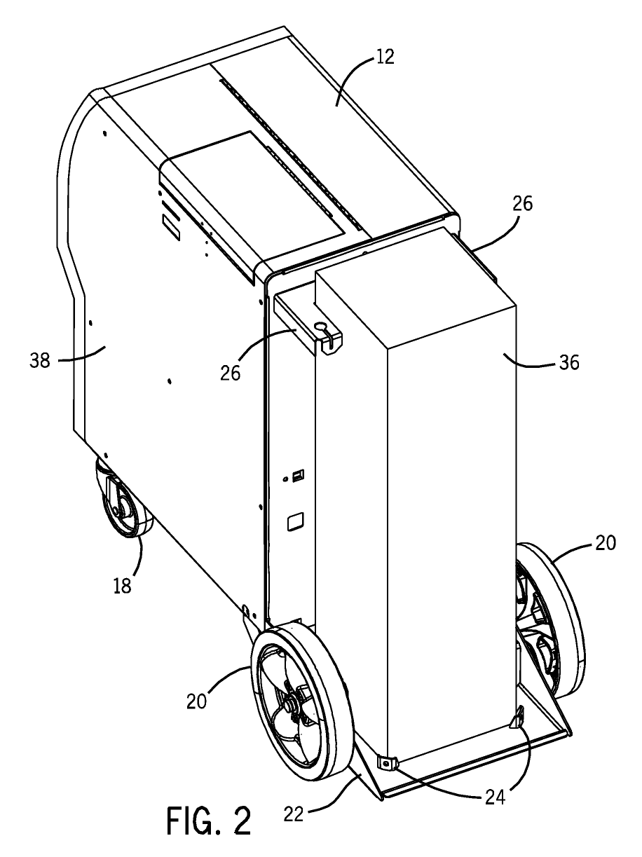

FIG. 2 illustrates a further embodiment of the welding system 10 of FIG. 1 in which the gas cylinder is replaced by a water cooler 36. In this embodiment, the lower portion of the water cooler 36 is secured against the back panel 38 of the welding machine by a tray 22 with risers or lifting tabs 24. The top portion of the water cooler 36 is secured with a square bracket 26. The geometry of the present invention allows for the addition of water cooling capabilities without sacrificing the portability of the welding system since the water cooler 36 is still placed on a unit with two sets of wheels 18, 20. Many water coolers will include refrigeration systems that are powered by external power sources, and the welding machine 12 may provide such a power source (e.g, an auxiliary power receptacle) into which a water cooler power cable can plug, eliminating the need for extension cords, reducing wire clutter, and making the entire system transportable as a collective unit. The versatility of the tray 22 and bracket 26 securement system of the present invention allows for easy conversion of the welding system 10 between water and air cooled operation modes. Similarly, the tray and bracket may be sold and installed as an option or retrofitted kit, making existing systems convertible to accommodate water coolers and/or such coolers with gas cylinder.

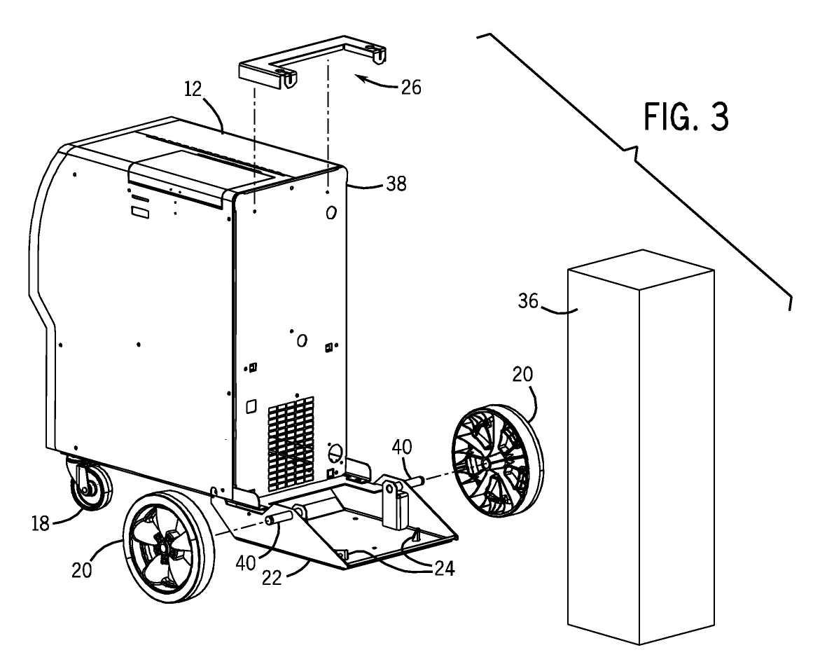

FIG. 3 is an exploded top perspective view of the exemplary welding system 10 of FIG. 2. The back panel 38 of the welding machine 12 may contain apertures for system exhaust, power plugs, gas lines, and so forth (not shown). In the illustrated embodiment, the tray 22 is secured to the bottom portion of the welding machine 12 and supports two axles 40 extending laterally from the tray 22 for receiving wheels 20. The bracket 26 secures to the upper portion of the back wall 38 of the welding machine 12. In other configurations, the axle and wheels may be separately supported, such as directly on the welding machine enclosure or frame.

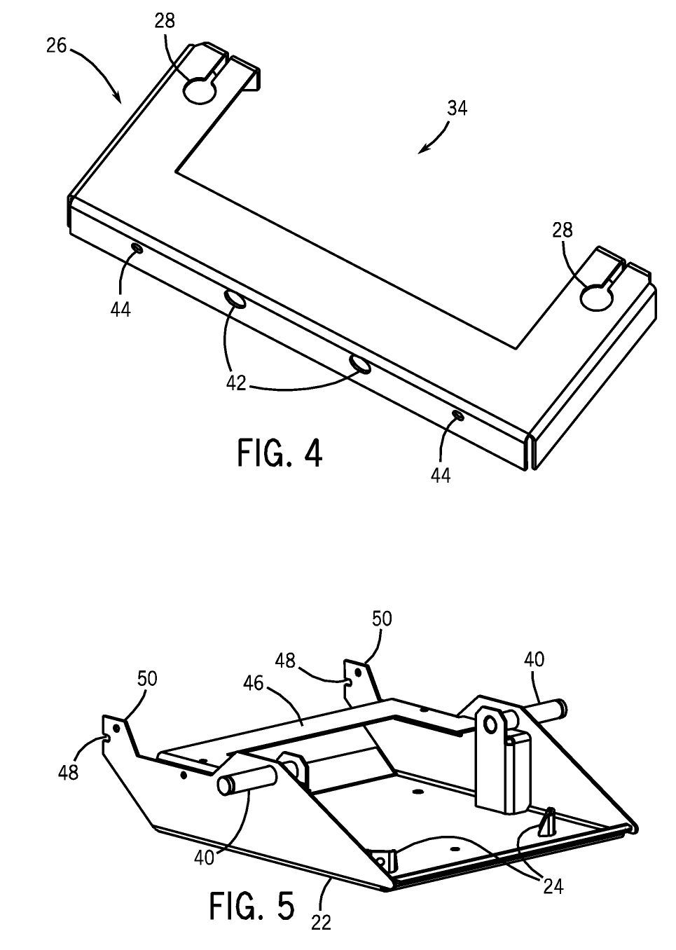

FIG. 4 illustrates the bracket 26 used to secure the upper portion of the water cooler 36 or gas cylinder 32, which fit into the square recess 34. Apertures 28 on the two extensions from the base of the bracket 26 may be outfitted with a securement apparatus. Large apertures 42 provide additional means for securing the water cooler 36 to the bracket. Small apertures 44 allow for securement of the bracket 26 to the back panel 38 of the welding machine 12.

FIG. 5 illustrates the tray 22 used to support and secure the lower portion of the water cooler 36 or the gas cylinder 32. A recess is formed between the risers or lifting tabs 24 and the lower bracket 46 in which the bottom portion of the water cooler 36 or the gas cylinder 32 is positioned. Axles 40 extend outward from both sides of the tray 22 to support wheels 20 for portability. Loopholes 48 and apertures 50 on either side of the tray 22 allow it to be removably secured to the welding machine 12, enabling easy replacement and transfer between machines.

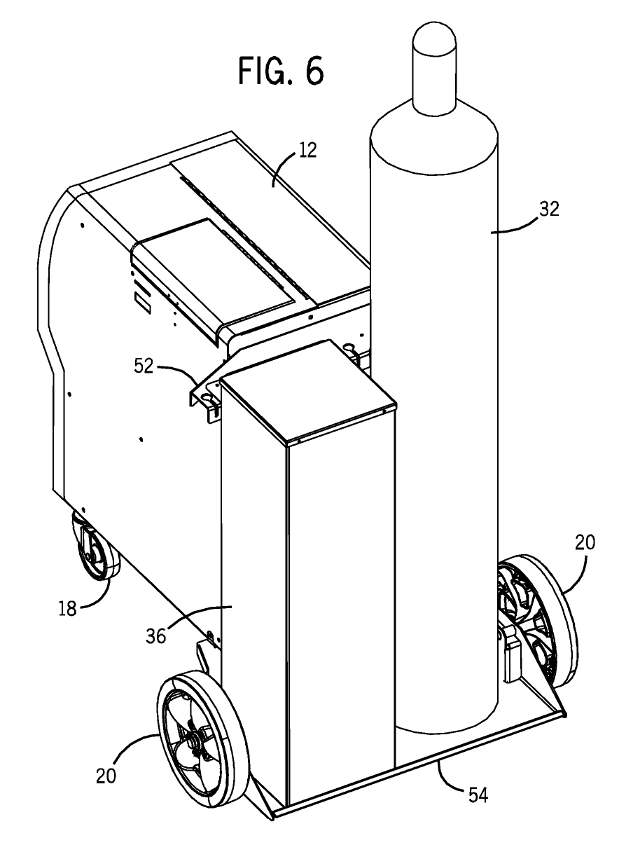

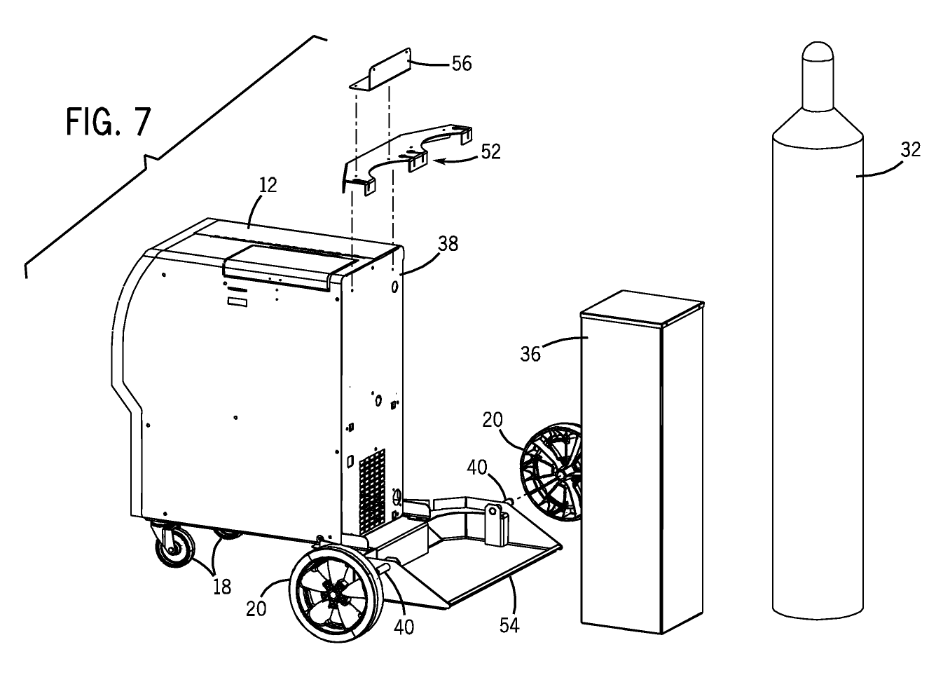

FIG. 6 is a further embodiment of the exemplary welding system 10 of FIG. 1, securing both a gas cylinder 32 and a water cooler 36 on the rear portion of the welding machine 12. In this embodiment, the lower portion of the water cooler 36 and the lower portion of the gas cylinder 32 are secured against the back panel 38 of the welding machine (see FIG. 7) by a double tray 54. A double bracket 52 is secured to the upper portion of the back side of the welding machine 12. The double bracket 52 contains a first recess against which the top portion of the water cooler 36 is positioned and a second recess in which the top portion of the gas cylinder 32 is positioned. Here again, the particular form and shape of these recesses may differ, with presently contemplated configurations including rectangular and round recesses, although other configurations may be used. Securement apparatuses 30 fit in the apertures 28 (see FIG. 8) and extend around the top portion of the gas cylinder 32 and the water cooler 36 to secure them within the double bracket 52. The securement apparatuses 30 may be but are not limited to chains, ropes, metal brackets, and so forth. In this embodiment, the traditionally supported gas cylinder 32 need not be removed from the welding system for the incorporation of the water cooler 36. Furthermore, a set of small wheels 18 and a set of large wheels 20 still connect to the welding system 10 to avoid a loss of portability. Moreover, as in the case of the first embodiment, the double tray and bracket may be provided as an option and may be retrofitted to existing welding machines where a water cooler and/or gas cylinder were previously separately supported.

FIG. 7 is an exploded top perspective view of the exemplary welding system of FIG. 6. The back panel 38 of the welding machine 12 may contain apertures for system exhaust, electrical power plugs (e.g., for powering the water cooler), gas lines, and so forth (not shown). The double tray 54 is secured to the bottom portion of the welding machine 12 and supports two axles 40 extending laterally from the tray 54 for receiving wheels 20.

The double bracket 52 illustrated in FIG. 8 secures to the upper portion of the back wall 38 of the welding machine 12. In one embodiment, an L-shaped abutment bracket 56 removably secures to the top of one round recess to create a flat surface against which the water cooler 36 may be secured. The abutment bracket 56 contains small apertures 58 for securement to the double bracket 52 and the water cooler 36. Small apertures 60 on the double bracket 52 provide means for securement to the back of the welding machine 12. Additional apertures 62 provide means for an additional abutment bracket to be added to the second round recess of the double bracket 52. In this embodiment, the addition or removal of abutment brackets 56 outfits the double bracket 52 for use with various combinations of gas cylinders 32 and/or water coolers 36.

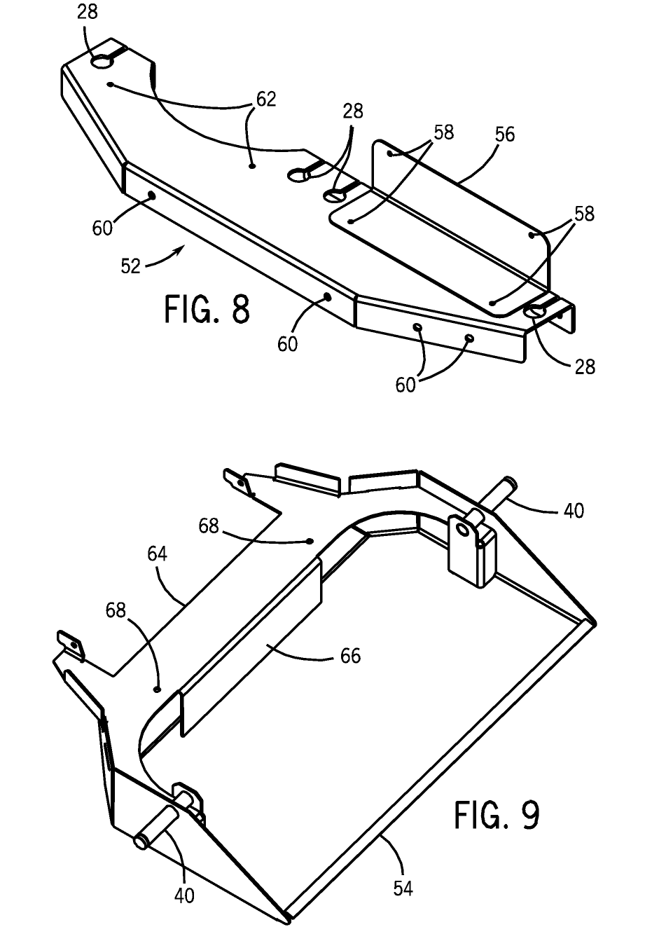

FIG. 9 illustrates the double tray 54 that is used to support the water cooler 36 and the gas cylinder 32 in the embodiment illustrated in FIG. 6. The double tray 54 supports axles 40 extending laterally outward for receiving wheels to maintain portability of the welding system 10. A bracket 64 with a back panel 66 attaches to the double tray 54 and provides a recess in which the water cooler 36 and gas cylinder 32 are secured. Additional apertures 68 on the top of the bracket 64 provide additional securement means.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for securing accessory equipment to a welding machine comprising:
a tray configured to be secured to a lower position on the welding machine and dimensioned to support a cooling system for cooling water circulated through a welding torch;
a holder configured to be secured to an upper position on the welding machine and to lodge the cooling system in a recess formed in the holder to stabilize the cooling system when disposed on the tray.

2. The system of claim 1, wherein the tray is configured to alternatively support a cylinder of welding gas in place of the cooling system, and the holder is configured to lodge the cylinder in the recess formed in the holder to stabilize the cylinder when disposed on the tray.

3. The system of claim 1, wherein the tray is configured to support both the cooling system and a cylinder of welding gas, and the holder is configured to lodge the cylinder in one recess formed in the holder and the cooling system in a second recess formed in the holder when the cylinder and the cooling system are both disposed on the tray.

4. The system of claim 1, comprising a restraining member configured to interface with the holder to restrain the cylinder or the cooling system.

5. The system of claim 4, wherein the restraining member includes a chain configured to partially encircle the cylinder when the cylinder is disposed on the tray.

6. The system of claim 4, wherein the restraining member includes a bracket configured to partially surround the cooling system when the cooling system is disposed on the tray.

7. The system of claim 1, wherein the tray supports an axle extending laterally from the tray for receiving wheels.

8. The system of claim 1, wherein the recess formed in the holder is generally rectangular and dimensioned to alternatively receive part of an enclosure of the cooling system or the cylinder.

9. A system for securing accessory equipment to a welding machine comprising:
a welder having an enclosure
a tray secured to a lower position on the welder and dimensioned to support a cooling system for cooling water circulated through a welding torch;
a holder secured to an upper position on the welder and configured to lodge the cooling system in a recess formed in the holder to stabilize the cooling system when disposed on the tray.

10. The system of claim 9, wherein the tray and holder are secured to a rear panel of the welder opposite from a welding control panel.

11. The system of claim 9, wherein the tray and holder are separately secured to the welder.

12. The system of claim 9, wherein the tray is configured to alternatively support a cylinder of welding gas in place of the cooling system, and the holder is configured to lodge the cylinder in the recess formed in the holder to stabilize the cylinder when disposed on the tray.

13. The system of claim 9, wherein the tray is configured to support both the cooling system and a cylinder of welding gas, and the holder is configured to lodge the cylinder in one recess formed in the holder and the cooling system in a second recess formed in the holder when the cylinder and the cooling system are both disposed on the tray.

14. The system of claim 9, comprising a restraining member configured to interface with the holder to restrain the cylinder or the cooling system.

15. The system of claim 14, wherein the restraining member includes a chain configured to partially encircle the cylinder when the cylinder is disposed on the tray.

16. The system of claim 14, wherein the restraining member includes a bracket configured to partially surround the cooling system when the cooling system is disposed on the tray.

17. The system of claim 9, wherein the tray supports an axle extending laterally from the tray for receiving wheels on which the welder can be rolled.

18. A method for securing accessory equipment to a welding machine comprising:
securing a tray to a lower position on the welding machine, the tray being dimensioned to support a cooling system for cooling water circulated through a welding torch;
securing a holder to an upper position on the welding machine, the holder being configured to lodge the cooling system in a recess formed in the holder to stabilize the cooling system when disposed on the tray.

19. The method of claim 18, wherein the tray is dimensioned to alternatively support a welding gas cylinder in place of the cooling system, and the holder is configured to alternatively stabilize the cylinder when disposed on the tray.

20. The method of claim 18, wherein the tray is dimensioned to support both the cooling system and a welding gas cylinder, and the holder is configured to stabilize both the cooling system and the cylinder when both are disposed on the tray.
